(19) United States
(12) Patent Application Publication
(10) Pub. No.: US 2023/0304482 A1
(43) Pub. Date: Sep. 28, 2023

(54) FUEL PUMP DEVICES, SYSTEMS, AND METHODS

(71) Applicant: Cummins Inc., Columbus, IN (US)

(72) Inventors: Donald J. Benson, Columbus, IN (US); Karthik Sethuraman, Columbus, IN (US); Michael A. Lucas, Columbus, IN (US); Eric A. Benham, Columbus, IN (US); Richard E. Duncan, Greenwood, IN (US)

(21) Appl. No.: 18/326,230

(22) Filed: May 31, 2023

Related U.S. Application Data
(63) Continuation of application No. PCT/US21/61768, filed on Dec. 3, 2021.
(60) Provisional application No. 63/120,944, filed on Dec. 3, 2020.

(51) Int. Cl. F04B 7/00; F04B 53/10; F02M 59/46

(52) U.S. Cl. CPC F04B 7/0076; F04B 53/1022; F04B 53/1035; F02M 59/466

(57) ABSTRACT

A pump inlet valve includes a valve body and a plunger assembly. The valve body includes a valve body cavity. The plunger assembly is arranged within the valve body cavity and includes a plunger body, a plunger barrel formed at the plunger body so as to form a plunger barrel volume, and a plunger. The plunger is configured to move within the plunger barrel to thereby allow a fluid to flow past the plunger assembly when the plunger is in an open position and to inhibit the fluid from flowing past the plunger assembly when the plunger is in a closed position. The plunger is configured to allow continuous fluid communication between the plunger barrel volume and a supply inlet, through which fluid is supplied to the pump inlet valve.

### FIELD OF THE DISCLOSURE

The present disclosure generally relates to fuel pumps for an engine, and more specifically, to valves for high-pressure fuel pumps in an internal combustion engine.

### BACKGROUND

High-pressure fluid pump assemblies are often used to pump fuel in common rail fuel systems for internal combustion engines. High-pressure fuel pump assemblies are typically cam driven and employ an active inlet valve, which controls a filling flow of fluid from a low-pressure side of the fluid pump to a high-pressure side of the fluid pump. So configured, the cam can act to increase a swept volume at a high-pressure side of the fuel pump by retracting a plunger and act to decrease the swept volume at the high-pressure side of the fuel pump by allowing the plunger to return from retraction. In operation, the inlet valve is open when the plunger is retracting and when the high-pressure side of the fuel pump is full, at which point it is possible for fuel to spill over into the low-pressure side of the fuel pump. Physical systems such as those employing electromagnetism are often used to actuate the inlet valve to thereby toggle between allowing fluid to flow into the fluid pump and preventing fluid from flowing into the fluid pump. However, during operation, it is common that there are pressure differentials between the instantaneous pressure at the distal end of the inlet valve opposite of the high-pressure side of the plunger and the pressure in the low-pressure side of the pump. For example, when the inlet valve is open and fluid is either flowing into the high-pressure fuel pump from a fuel supply or spilling from the high-pressure side of the pump, pressure dynamics in the system and pressure drops resulting from flow through passages can act to create a pressure differential within the inlet valve. Under these circumstances, changing and dynamic pressure differentials between the pressure at the distal end of the inlet valve opposite of the high-pressure side of the plunger and the pressure in the low-pressure side of the pump create differential pressure induced forces which negatively affect the stability and consistency of both the opening and closing responses of the operation of the inlet valve.

### SUMMARY

The present disclosure advantageously provides cost effective fuel pumps that include devices, systems, and methods for reducing pressure differentials within an inlet valve. For example, promoting pressure equalization between closed-off portions, including cavities in the low-pressure side of the pump inlet valve that have flow restrictive passages connecting them to a low-pressure fluid supply, can improve consistency and performance of the pump inlet valve by acting to reduce pressure induced forces caused by pressure buildups in the closed off cavities. All of these features can be included in a compact, robust design, according to principles of the present disclosure.

In a first example, a pump inlet valve can include a valve body and a plunger assembly. The valve body can include a valve body cavity. The plunger assembly can be arranged within the valve body cavity and can include a plunger body, a plunger barrel formed at the plunger body so as to form a plunger barrel volume, and a plunger. The plunger can be configured to move within the plunger barrel to thereby allow a fluid to flow past the plunger assembly when the plunger is in an open position and to inhibit the fluid from flowing past the plunger assembly when the plunger is in a closed position. The plunger can be configured to allow continuous fluid communication between the plunger barrel volume and a supply inlet, through which fluid is supplied to the pump inlet valve. In examples, the plunger can include an elongate plunger body that has a plunger body outer surface, a first passage extending along a length of the elongate plunger body and open to the plunger barrel, and a second passage extending transversely from the first passage to the outer surface of the plunger body and open to the supply inlet such that the plunger barrel and supply inlet are in continuous fluid communication.

In further examples of the first example, the plunger can include a plunger body top portion, a plunger body bottom portion, and a transition portion between the plunger body top portion and the plunger body bottom portion. The plunger body top portion can have a first major diameter and the transition portion has a second major diameter, wherein the first major diameter is greater than the second major diameter. In examples, the second passage can be positioned proximate to the transition portion. The second passage can longitudinally extend through the elongate plunger body such that the second passage has at least two openings at the plunger body outer surface. The second passage can extend at a substantially perpendicular angle from the plunger barrel longitudinal axis toward the plunger body outer surface. In examples, the first passage can longitudinally extend along an elongate plunger body longitudinal axis. In examples, the first passage can extend along the plunger body outer surface. In other examples, each of the first and second fluid passages can be formed within the plunger body so as to be contained within the plunger body.

Continuing with the first example, the plunger assembly can include a drive assembly configured to cause the plunger to move between the open position and the closed position. In examples, the drive assembly can include a biasing member that is configured to bias the plunger relative to the plunger barrel. In examples, the biasing member can engage a plunger stop that is connected to the plunger and configured to inhibit movement of the plunger in the direction along a plunger barrel longitudinal axis. In examples, a retainer positioned at a biasing member top end of the biasing member is configured to inhibit radial movement of the biasing member top end.

In the second example, the fuel pump assembly can include a pump assembly in the pump inlet valve. The pump assembly can include a pump body and a pumping chamber formed by a pump barrel extending through the pump body. The pump body can include a supply inlet through which the fluid enters the pump body and a transfer zone through which the fluid exits the pump inlet valve and flows toward the pumping chamber. A pump inlet valve can be in fluid communication with the pumping chamber and can be configured to control a flow of fluid into the pumping chamber. A plunger assembly can be arranged within the valve body cavity and can include a plunger body, a plunger barrel formed at the plunger body.

A plunger can be configured to move within the plunger barrel to thereby allow a fluid to flow past the plunger assembly when the plunger is in an open position and to inhibit the fluid from flowing past the plunger assembly when the plunger is in a closed position. The plunger can be configured to allow continuous fluid communication between the plunger barrel and a supply inlet, through which fluid is supplied to the pump inlet valve. In examples, the elongate plunger body includes a plunger bottom portion, a plunger top portion, and a transition portion between the plunger bottom portion and the plunger top portion, and wherein the bottom portion and the transition portion are positioned between the pumping chamber and the supply inlet.

Continuing with the second example, a plunger barrel longitudinal axis and a plunger barrel longitudinal axis can be coaxially aligned within the fuel pump assembly. In this regard, a portion of the supply inlet can be formed between the pump body and the valve body. In examples, the second passage can be positioned at the transition portion and is open to the supply inlet both when the plunger is in the open position and when the plunger is in the closed position.

In a third example of the present disclosure, methods of operating a fuel supply system are disclosed. The method can include supplying low-pressure fuel to a fuel pump assembly at a low-pressure side. The method can include controlling the flow of fuel from a low-pressure side of the fuel pump assembly into a high-pressure side of the fuel pump assembly via a pump inlet valve while equalizing fluid pressure between a plunger barrel of the pump inlet valve and a supply inlet of the fuel pump assembly. In examples, controlling the flow of fuel from a low-pressure side of the fuel pump assembly into a high-pressure side of the fuel pump assembly via a pump inlet valve can include allowing, compulsorily, fuel to flow past the pump inlet valve while the pump inlet valve is in an open position. In examples, controlling the flow of fuel from a low-pressure side of the fuel pump assembly into a high-pressure side of the fuel pump assembly via a pump inlet valve can include inhibiting the flow of fluid from flowing past the valve when the pump inlet valve moves from the open position to a closed position.

For the method, a plunger can be configured to equalize the fluid pressure between each or some subset of the plunger barrel volume, the distal end of the pump inlet valve which opposes the high-pressure side of the pump inlet valve, and the supply inlet of the fuel pump assembly such that the supply inlet and a plunger barrel volume formed at the plunger barrel are in continuous fluid communication. In examples, the plunger includes a first passage that extends along an elongate plunger body longitudinal axis, and a second passage that extends transversely from the first passage to an outer surface of the plunger.

Additional features and advantages of the present disclosure will become apparent to those skilled in the art upon consideration of the following detailed description of the illustrative embodiments exemplifying the disclosure as presently perceived.

### BRIEF DESCRIPTION OF THE DRAWINGS

The above-mentioned and other features and advantages of this disclosure, and the manner of obtaining them, will become more apparent, and will be better understood by reference to the following description of the exemplary embodiments taken in conjunction with the accompanying drawings, wherein:

FIG. 1A is a cross section of a fuel pump assembly according to principles of the present disclosure;

FIG. 1B is a close up view of components of the fuel pump assembly shown in FIG. 1A; and

FIG. 2 is a flowchart of a method of operating an engine, according to principles of the present disclosure.

Corresponding reference characters indicate corresponding parts throughout the several views. Although the drawings represent embodiments of various features and components according to the present disclosure, the drawings are not necessarily to scale and certain features may be exaggerated in order to better illustrate and explain the present disclosure. The exemplification set out herein illustrates an embodiment of the invention, and such an exemplification is not to be construed as limiting the scope of the invention in any manner.

### DETAILED DESCRIPTION OF THE DRAWINGS

For the purposes of promoting an understanding of the principles of the present disclosure, reference is now made to the embodiments illustrated in the drawings, which are described below. The exemplary embodiments disclosed herein are not intended to be exhaustive or to limit the disclosure to the precise form disclosed in the following detailed description. Rather, these exemplary embodiments were chosen and described so that others skilled in the art may utilize their teachings. It is not beyond the scope of this disclosure to have a number (e.g., all) the features in a given embodiment to be used across all embodiments.

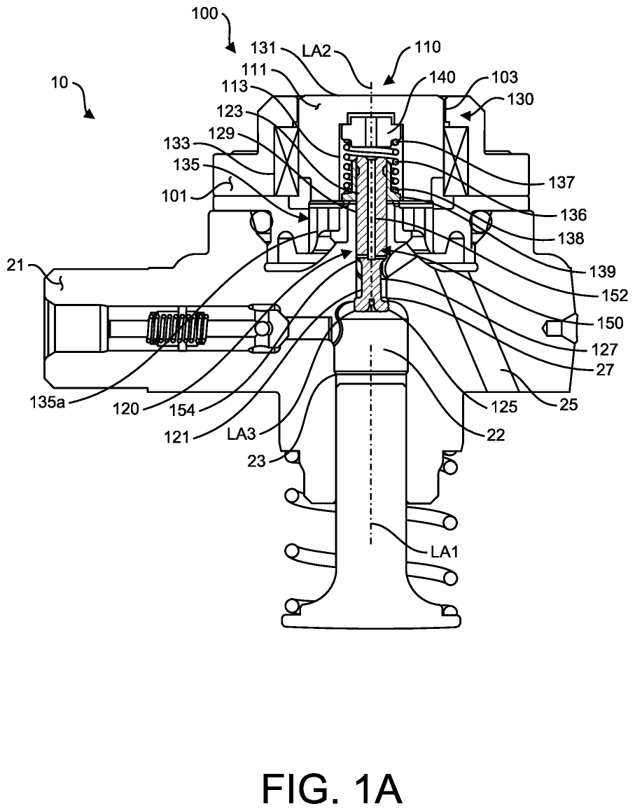

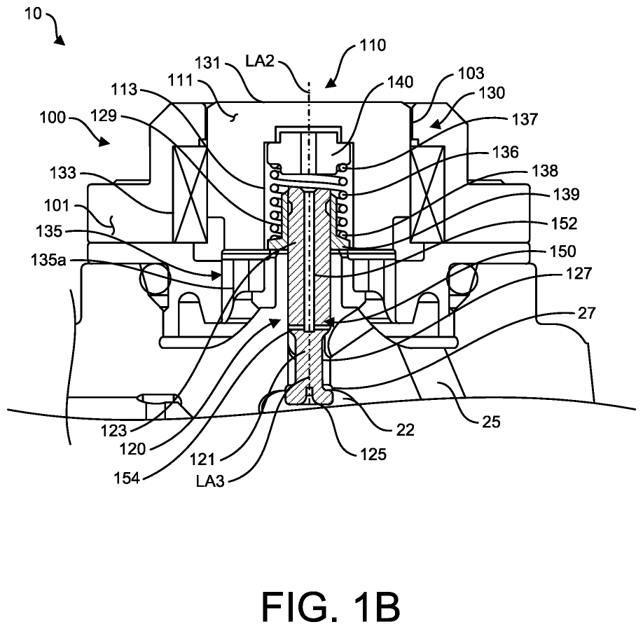

FIGS. 1A and 1B show various aspects of a fuel pump assembly 10 according to aspects of the present disclosure. FIG. 1A is a cross section of a fuel pump assembly 10. FIG. 1B is a close-up view of components of the fuel pump assembly 10 shown in FIG. 1A. The example shown in these figures is just one of many examples.

For illustration purposes, the fuel pump assembly 10 shown is a high-pressure fuel pump 10 for use with an internal combustion engine. As shown in FIG. 1A, the fuel pump assembly 10 can include a pump body 21 and a pumping chamber 22 formed by a pump barrel 23 extending through the pump body 21 and having a pump barrel longitudinal axis LAL The pump body 21 can include a supply inlet 25 through which the fluid enters the pump body 21 and a transfer zone 27 through which the fluid inlet valve and is flowed toward the pumping chamber. An outlet check valve 28 controls the flow of fuel from the pumping chamber 22 to a high-pressure circuit via a flow outlet passage 29. The fuel pump assembly 10 can include a pump inlet valve 100 that is in fluid communication with the pumping chamber 22. The pump inlet valve 100 can be in fluid communication with the pumping chamber 22 and can be configured to control a flow of fluid into the pumping chamber 22. Controllable portions (e.g., a plunger assembly 110) of the pump inlet valve 100 can be positioned between the supply inlet 25 and transfer zone 27 and proximate to the pumping chamber 22. In this regard, the pump inlet valve 100 can control and thereby regulate a flow of fluid into the pumping chamber 22.

A pump inlet valve 100 can be configured to control a flow of fluid into the pumping chamber 22. The pump inlet valve 100 can include a valve body 101 that includes a valve body cavity 103. In examples, a portion of the supply inlet 25 can be formed between the pump body 21 and the valve body 101. The pump inlet valve 100 can include a plunger assembly 110 that is arranged within the valve body cavity 103. The plunger assembly 110 can include a plunger assembly body 111, a plunger barrel 113 formed at the plunger assembly body 111 thereby defining a plunger barrel volume 114, and a plunger 120. For illustration purposes, the plunger 120 can include a plunger body 121 with a plunger body top portion 123, a plunger body bottom portion 125, and a transition portion 127 between the plunger body top portion 123 and the plunger body bottom portion 125. As such, at least the plunger body top portion 123 can be received in the plunger barrel volume 114, and the plunger body bottom portion 125 can be at an opposing end of the plunger 120 such that the plunger body bottom portion 125 is adjacent the pumping chamber 22. As well, the plunger 120 can include a plunger body outer surface 129 positioned along a length of the surface area of the plunger 120.

The pump inlet valve 100 can control and thereby regulate the flow of fluid into the pumping chamber 22 by actuating the pump inlet valve 100. The plunger 120 can be movably received in the plunger barrel 113. The plunger 120 can be configured to move within the plunger barrel 113 to thereby allow a fluid to flow past the plunger assembly 110 (e.g., via the transfer zone 27) when the plunger 120 is in an open position and to inhibit the fluid from flowing past the plunger assembly 110 when the plunger 120 is in a closed position. In this regard, corresponding to the open and closed positions of the plunger, the supply inlet 25 can be closed and opened respectively. When the supply inlet 25 is closed, fluid can be inhibited from flowing between (e.g., to and from) the pump inlet valve and the pumping chamber 22, which can be at a low-pressure side of the pump assembly. The plunger 120 can be configured to allow continuous fluid communication between the plunger barrel 113 and the supply inlet 25, through which fluid is flowed toward the pump inlet valve 100, while the plunger 120 moves between the closed position and the open position.

Physical systems employing electromagnetism can be used to cause the plunger 120 to move between the open position in the closed position. The plunger assembly 110 can include a drive assembly 130 that is configured to cause the plunger 120 to move between the open position and the closed position. For illustration purposes, the fuel pump assembly 10 shown is an electromagnetically controlled pump inlet valve 100. In examples, a plunger barrel longitudinal axis LA2 and the pump barrel longitudinal axis LA1 can be coaxially aligned within the fuel pump assembly 10. A stator 131 and a stator coil 133 may be positioned about the plunger 120. In examples, the plunger barrel 113 can be formed as a recess within the stator 131. An armature 135 can be used in connection with the stator 131 to cause the plunger 120 such that when an electric current is induced inside the stator coil 133, a magnetic field is induced. The induced magnetic field thereby produces an electromagnetic force, which causes the plunger 120 to move between the open and closed positions.

As can be seen in FIG. 1A, operation of the fuel pump assembly 10 can cause pressure imbalances within the fuel pump assembly 10. As illustrated here, the armature 135 is a generally solid structure that is pulled and released by the drive assembly 130. Under these circumstances, a gap between the armature 135 and the stator 131 is moves between being closed and opened (e.g., decreased and increased) as the armature 135 is pulled and released respectively by the drive assembly 130. During operation, the plunger 120 can be in the open position on a compulsory basis, and as the cam rotates the fuel pump assembly 10, fluid from the pumping chamber 22 can be allowed to fill and backflow into the pump inlet valve 100 and into the pump barrel 23. As well, the armature 135 includes through holes 135a through which fluid is allowed to flow into either side of the armature 135 to reduce pressure imbalances around the armature 135, and fluid that flows through the armature 135 may enter the plunger barrel 113.

When it is determined that the pump inlet valve 100 should close (e.g., to seal the pumping chamber 22 to pressurize fluid), the armature 135 is moved by the drive assembly 130 to close the gap, which acts to separate the flow of fluid at a fluid volume adjacent the plunger top portion. This separation can result in a pressure of the plunger barrel volume 114 being different from that of the supply inlet 25 at least for the aforementioned reasons. In this regard, fluid flow in the plunger barrel volume 114 would otherwise be separated from the supply inlet 25 save for the introduction of the second passage 154 in combination with the first passage 152. Under these circumstances, pressure can be regulated to promote pressure equalization across the plunger 120 (e.g., between the plunger barrel volume 114 and the supply inlet 25) to ensure proper operation (e.g., proper opening and closing in subsequent operations) thereof.

No matter the operational or flow state of the pump inlet valve 100, using the principles of the present disclosure, the plunger barrel volume 114 and the supply inlet 25 can be in continuous fluid communication. In this regard, the first passage 152 and the second passage 154 in combination can act to provide a flow passage between the plunger barrel volume 114 and the supply inlet 25 for all operating states of the plunger 120. These operating states correspond to, for example, a fully open, opening, fully closed, and closing transfer zone 27. In addition, or in alternative, the first passage 152 and the second passage 154 in combination act to provide a flow passage between the plunger barrel volume 114 and the supply inlet 25 for all states of flow. These flow states including when fluid flows into the pumping chamber 22 from the supply inlet 25, when fluid flows from the pumping chamber 22 to the supply inlet 25, and when there is no fluid flow between the pumping chamber 22 and the supply inlet 25 (e.g., when the transfer zone 27 has been closed). Through employing principles of the present disclosure, continuous fluid communication between each or some subset of the plunger barrel volume 114, the distal end of the pump inlet valve 100 that opposes the high-pressure side of the pump inlet valve, and the supply inlet 25 can be achieved. In addition, it is contemplated that continuous fluid communication may be some subset of all operating states of the plunger 120 without departing from the scope of this disclosure.

In examples, the drive assembly 130 can include a biasing member 136 (such as an axial spring or torsional spring) that is configured to bias the plunger 120 relative to the plunger barrel 113. For illustration purposes, the biasing member 136 can have a biasing member top end 137 and a biasing member bottom end 138 that is opposite the biasing member top end 137. In examples, the biasing member 136 can be coupled to a plunger stop 139 that is connected to the plunger 120 and configured to inhibit movement of the plunger 120 in the direction along a plunger barrel longitudinal axis LA2. In examples, a retainer 140 positioned at the biasing member top end 137 of the biasing member 136 is configured to inhibit radial movement of the biasing member top end 137. In combination with the drive assembly 130, the biasing member 136 can cause the plunger 120 to move between the open and closed positions. For example, when activated, the drive assembly 130 can move the plunger 120 into the closed position (thereby closing the gap) against a biasing force of the biasing member 136 (e.g., due to compression thereof). On the other hand, when the drive assembly 130 is deactivated, the biasing member 136 can move the plunger to the open position (e.g., as the biasing member 136 becomes less compressed than when the drive assembly 130 is activated).

Turning to FIG. 1B, to promote fluid communication between portions of the pump inlet valve 100, including the plunger barrel volume 114, via the plunger 120, portions of one or more flow passages 150 formed at the plunger 120 may extend to the plunger body outer surface 129 at more than one location. For example, the plunger body 121 as shown is an elongate plunger body 121 and can have a plunger body outer surface 129, a first passage 152, and a second passage 154. In examples, the first passage 152 can longitudinally extend along an elongate plunger body longitudinal axis LA3. The first passage 152 can extend along a length of the elongate plunger body 121 and can be open to the plunger barrel 113. In some such examples, the first passage 152 can extend along a majority of a length of the plunger 120. In other examples, the first passage 152 can extend along a portion of the entire length of the plunger 120.

The second passage 154 can extend transversely from the first passage 152 to the plunger body outer surface 129 of the elongate plunger body 121 and can be open to the supply inlet 25 such that the plunger barrel volume 114 and the supply inlet 25 are in fluid communication. To begin, the second passage 154 can extend at a substantially perpendicular angle from the elongate plunger body longitudinal axis LA3 toward the plunger body outer surface 129. In examples, the second passage 154 can be positioned proximate to the transition portion 127. For example, the bottom portion and the transition portion 127 can be positioned between the pumping chamber 22 and the supply inlet 25. In this regard, the second passage 154 is positioned at the transition portion 127 and is open to the supply inlet 25 both when the plunger 120 is in the open position and in the closed position. Similar to the first passage 152, the second passage 154 can extend entirely or partially through a thickness of the elongate plunger body 121. For example, the second passage 154 can longitudinally extend through the elongate plunger body 121 such that the second passage 154 has at least two openings at the plunger body outer surface 129. In examples, each of the first and second fluid passages 152, 154 can be formed within the plunger body 121 so as to be contained within the plunger body 121.

To withstand both mechanical and fluid dynamics acting on the plunger 120 during operation of the pump inlet valve 100, the plunger 120 can have a robust construction. In this regard, the plunger 120 can include an elongate plunger body 121 with one or more flow passages 150 at the elongate plunger body 121. As noted prior, for illustration purposes, the plunger 120 can include a plunger body top portion 123, a plunger body bottom portion 125, and a transition portion 127 between the plunger body top portion 123 and the plunger body bottom portion 125. The plunger body top portion 123 has a first major diameter and the transition portion 127 has a second major diameter, wherein the first major diameter is greater than the second major diameter. Together, the plunger body top portion 123, the transition portion 127 and the plunger body bottom portion 125 define a surface area with a plunger body outer surface 129 of the plunger 120.

For manufacturing purposes, it should be noted that the first passage 152 and the second passage 154 can be formed as drillings in the plunger 120. For example, with the plunger 120 formed having an elongate plunger body 121, the first passage 152 can be formed as a central drilling along the elongate plunger body longitudinal axis LA3. Similarly, the second passage 154 can be formed as a cross drilling at an angle relative to the elongate plunger body longitudinal axis LA3. Under these circumstances, the plunger 120 can be axisymmetric about the elongate plunger body longitudinal axis LA3. In some examples, the cross drilling may extend entirely through a thickness of the elongate plunger body 121 while in other examples the cross drilling may not extend entirely through the thickness of the elongate plunger body 121. As has been discussed elsewhere herein, the angle of the cross drilling may be substantially perpendicular to the elongate plunger body longitudinal axis LA3 and thereby substantially perpendicular to the central drilling. It is noted, however, that the cross drilling may be at a different angle that is otherwise transverse to the elongate plunger body longitudinal axis LA3. In addition, the diameter of the any of these drillings may be constant or varied depending on the application. When assembled, the elongate plunger body longitudinal axis LA3 can be coaxially aligned with the plunger barrel longitudinal axis LA2.

When the first passage 152 is interior to the plunger body 121, the plunger body outer surface 129 can be relatively smooth so as not to negatively affect control of the radial position of the plunger 120. However, while in the illustrated examples, the first passage 152 is shown as being within the plunger body 121, it is contemplated that the first passage 152 can be positioned at the plunger body outer surface 129. For example, the first passage 152 can extend along the plunger body outer surface 129 such that the first passage 152 is at the exterior rather than at the interior of the elongate plunger body 121. For example, one or more fluid passages may be formed as a groove (not shown) at the plunger body outer surface 129. Such grooves may, for example, be spiral grooves or substantially straight grooves. Under these circumstances, the fluid regulating passage can be a portion or extension of the first passage 152 that is open to the supply inlet 25. In this way a pressure difference between fluid in the valve body cavity 103 and low-pressure fluid flowing in through the supply inlet 25 can still be minimized such that there is pressure equalization between the valve body cavity 103 and the supply inlet 25. It is recognized, however, that a design for first passages 152 extending along the plunger body outer surface 129 should accommodate, with limited to no interference, features such as plunger guides and/or the plunger stop 139, which is usually press fit to the plunger 120 at the plunger body outer surface 129.

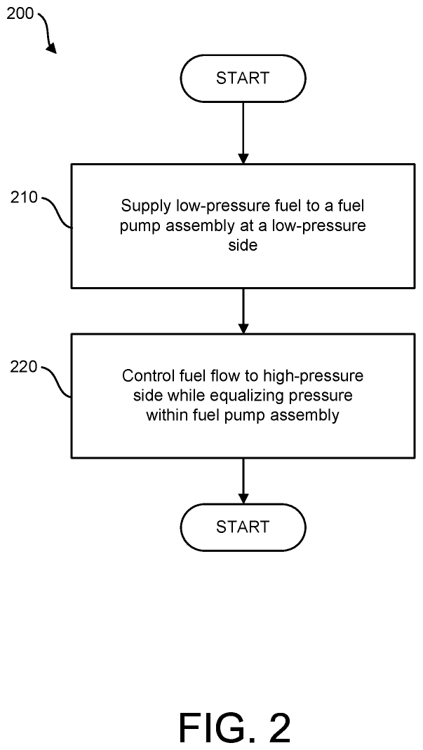

The present disclosure includes methods of operating a fuel supply system. FIG. 2 is a flowchart of a method 200 of operating an engine, according to principles of the present disclosure. With regard to the illustrated method 200, at step 210, the method 200 can include supplying low-pressure fuel to a fuel pump assembly at a low-pressure side. At step 220, the method 200 can include controlling the flow of fuel from a low-pressure side of the fuel pump assembly into a high-pressure side of the fuel pump assembly via a pump inlet valve while equalizing fluid pressure between a plunger barrel of the pump inlet valve and a supply inlet of the fuel pump assembly via a plunger. In examples, controlling the flow of fuel from a low-pressure side of the fuel pump assembly into a high-pressure side of the fuel pump assembly via a pump inlet valve can include allowing fluid to flow past the pump inlet valve while the pump inlet valve is in an open position and inhibiting the flow of fluid from flowing past the valve when the pump inlet valve moves from the open position to a closed position and when the pump inlet valve is in the closed position. In examples, the pump inlet valve can have the plunger biased toward the open position such that, for example, allowing fuel to flow past the pump inlet valve while the pump inlet valve is in an open position can be done on a compulsory basis.

Examples of the method 200 can employ pump inlet valves similar to those disclosed elsewhere herein, including the pump inlet valve. In examples of the method 200, a plunger can be configured to equalize the fluid pressure between the plunger barrel of the pump inlet valve and the supply inlet of the fuel pump assembly. In this regard, as noted above, the plunger can be configured to equalize the fluid pressure between the plunger barrel volume and the supply inlet in each operating state of the pump inlet valve, including when the plunger is in a closed position in which fuel is inhibited from flowing into the pumping chamber at the high-pressure side of the fluid pump. In such examples, the plunger can include a first passage that extends along an elongate plunger body longitudinal axis, and a second passage that extends transversely from the first passage to an outer surface of the plunger. In this regard, the first passage can longitudinally extend along an elongate plunger body longitudinal axis, and the second passage can extend at a substantially perpendicular angle from the elongate plunger body longitudinal axis toward the plunger body outer surface. In examples of the method 200, the second passage can be positioned at a plunger body transition portion.

It is well understood that methods that include one or more steps, the order listed is not a limitation of the claim unless there are explicit or implicit statements to the contrary in the specification or claim itself. It is also well settled that the illustrated methods are just some examples of many examples disclosed, and certain steps may be added or omitted without departing from the scope of this disclosure. Such steps may include incorporating devices, systems, or methods or components thereof as well as what is well understood, routine, and conventional in the art.

The connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements. The scope is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B or C may be present in a single embodiment; for example, A and B, A and C, B and C, or A and B and C.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art with the benefit of the present disclosure to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus

While the present disclosure has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practices in the art to which this invention pertains.

1. A pump inlet valve comprising:
a valve body that includes a valve body cavity; and
a plunger assembly that is arranged within the valve body cavity and that includes a plunger body, a plunger barrel formed at the plunger body so as to form a plunger barrel volume, and a plunger configured to move within the plunger barrel to thereby allow a fluid to flow past the plunger assembly when the plunger is in an open position and to inhibit the fluid from flowing past the plunger assembly when the plunger is in a closed position;
wherein the plunger is configured to allow continuous fluid communication between the plunger barrel volume and a supply inlet, through which the fluid is supplied to the pump inlet valve.

2. The pump inlet valve of claim 1, wherein the plunger includes an elongate plunger body that has a plunger body outer surface, a first passage extending along a length of the elongate plunger body and open to the plunger barrel, and a second passage extending transversely from the first passage to the plunger body outer surface and open to the supply inlet such that the plunger barrel and the supply inlet are in continuous fluid communication.

3. The pump inlet valve of claim 2, wherein each of the first passage and the second passage are formed within the plunger body so as to be contained within the plunger body.

4. The pump inlet valve of claim 1, wherein the plunger assembly includes a drive assembly configured to cause the plunger to move between the open position and the closed position.

5. The pump inlet valve of claim 4, wherein the drive assembly includes a biasing member that biases the plunger relative to the plunger barrel.

6. The pump inlet valve of claim 5, wherein the biasing member engages a plunger stop that is connected to the plunger and configured to inhibit movement of the plunger in a direction along a plunger barrel longitudinal axis.

7. The pump inlet valve of claim 4, wherein a retainer is configured to inhibit radial movement of a biasing member top end.

8. The pump inlet valve of claim 1, wherein the plunger includes a plunger body top portion that has a first diameter and a plunger body bottom portion that has a second diameter, wherein the first diameter is greater than the second diameter.

9. The pump inlet valve of claim 8, wherein the plunger further includes a transition portion positioned between the plunger body top portion and the plunger body bottom portion, and wherein a second passage is positioned at the transition portion.

10. The pump inlet valve of claim 1, wherein a passage longitudinally extends through an elongate plunger body of the plunger such that the second passage has at least two openings at a plunger body outer surface.

11. The pump inlet valve of claim 10, wherein a second passage extends at a substantially perpendicular angle from a plunger barrel longitudinal axis toward the plunger body outer surface.

12. A fuel pump assembly comprising:
a pump assembly comprising a pump body and a pumping chamber formed by a pump barrel extending through the pump body, the pump body including a supply inlet through which a fluid enters the pump body and a transfer zone through which the fluid exits a pump inlet valve and flows toward the pumping chamber;
the pump inlet valve in fluid communication with the pumping chamber and configured to control a flow of fluid into the pumping chamber, the pump inlet valve comprising:
a valve body that includes a valve body cavity; and
a plunger assembly that is arranged within the valve body cavity and that includes a plunger body, a plunger barrel formed at the plunger body so as to form a plunger barrel volume, and a plunger configured to move within the plunger barrel to thereby allow the fluid to flow past the plunger assembly when the plunger is in an open position and to inhibit the fluid from flowing past the plunger assembly when the plunger is in a closed position;
wherein the plunger is configured to allow continuous fluid communication between the plunger barrel volume and the supply inlet, through which the fluid is supplied to the pump inlet valve.

13. The fuel pump assembly of claim 12, wherein a portion of the supply inlet is formed between the pump body and the valve body.

14. The fuel pump assembly of claim 12, wherein a pump barrel longitudinal axis and a plunger barrel longitudinal axis are coaxially aligned within the fuel pump assembly.

15. The fuel pump assembly of claim 12, wherein the plunger includes an elongate plunger body that has a plunger bottom portion, a plunger top portion, and a transition portion between the plunger bottom portion and the plunger top portion, and wherein the transition portion and a plunger body bottom portion that extends from the transition portion are positioned between the pumping chamber and the supply inlet.

16. The fuel pump assembly of claim 15, wherein a second passage is positioned at the transition portion and is open to the supply inlet both when the plunger is in the open position and in the closed position.

17. The fuel pump assembly of claim 15, wherein the valve body cavity includes a drive assembly configured to cause the plunger to move between the open position and the closed position and a biasing member that is configured to bias the plunger relative to the plunger barrel.

18. A method of operating a fuel supply system, the method comprising:
supplying low-pressure fuel to a fuel pump assembly at a low-pressure side; and
controlling a flow of fuel from the low-pressure side of the fuel pump assembly into a high-pressure side of the fuel pump assembly via a pump inlet valve while equalizing fluid pressure between a plunger barrel of the pump inlet valve and a supply inlet of the fuel pump assembly.

19. The method of operating the fuel supply system of claim 18, wherein a plunger is configured to equalize the fluid pressure between the plunger barrel of the pump inlet valve and the supply inlet of the fuel pump assembly such that the supply inlet and a plunger barrel volume formed at the plunger barrel are in continuous fluid communication; and wherein the plunger includes a first passage that extends along an elongate plunger body longitudinal axis, and a second passage Preliminary Amendment that extends transversely from the first passage to an outer surface of the plunger.

20. The method of operating the fuel supply system of claim 18, wherein controlling the flow of fuel from the low-pressure side of the fuel pump assembly into the high-pressure side of the fuel pump assembly via the pump inlet valve comprises:
allowing, on a compulsory basis, fuel to flow past the pump inlet valve while the pump inlet valve is in an open position; and
inhibiting the flow of fuel from flowing past the pump inlet valve when the pump inlet valve moves from the open position to a closed position.
